(19) United States
(12) Patent Application Publication
(10) Pub. No.: US 2026/0131271 A1
(43) Pub. Date: May 14, 2026

(54) FILTER SYSTEM WITH A SECONDARY FILTER ELEMENT AND A PRIMARY FILTER ELEMENT, AND USE OF A SECONDARY FILTER ELEMENT IN A FILTER SYSTEM

(71) Applicant: MANN+HUMMEL GmbH, Ludwigsburg (DE)

(72) Inventors: Dennis STARK, Mauer (DE); Michael KAUFMANN, Meckenheim (DE); Klaus-Dieter RUHLAND, Meckenheim (DE); Tanja HEILMANN, Meckenheim (DE)

(21) Appl. No.: 19/413,489

(22) Filed: Dec. 9, 2025

Related U.S. Application Data
(63) Continuation of application No. PCT/EP2024/063268, filed on May 14, 2024.

(30) Foreign Application Priority Data
Jun. 14, 2023 (DE) 10 2023 115 460.5

(51) Int. Cl. B01D 46/00; B01D 46/24; B01D 46/64

(52) U.S. Cl. CPC B01D 46/0005; B01D 46/0036; B01D 46/2411; B01D 46/64; B01D 2265/024; B01D 2265/029

(57) ABSTRACT

A filter system has a primary filter element and a secondary filter element arranged in a housing between fluid inlet and fluid outlet. The secondary filter element is arranged inside the primary filter element. The primary and secondary filter elements are flowed through sequentially by a fluid to be filtered. The secondary filter element contains an adsorption agent and has a coupling device. The housing has a coupling element at the fluid outlet for coupling to the coupling device. The secondary filter element has a filter medium body which extends along a longitudinal axis and surrounds a hollow interior. The coupling device is arranged at an open end of the filter medium body and configured to be coupled rotationally fixed to the primary filter element. The coupling device has a thread for engaging a thread of the coupling element of the housing complementary to the thread of the coupling device.

### CROSS-REFERENCE TO RELATED APPLICATIONS

This application is a continuation application of international application No. PCT/EP 2024/063268 having an international filing date of May 14, 2024, and designating the United States, the international application claiming a priority date of Jun. 14, 2023, based on prior filed German patent application No. 10 2023 115 460.5, the entire contents of the aforesaid applications being incorporated herein by reference.

### BACKGROUND

The invention concerns a filter system with a secondary filter element and a primary filter element, for example for filtration of a gaseous fluid, for example air, as well as the use of a secondary filter element in a filter system.

Filter systems with a primary filter element and a secondary filter element which is arranged downstream with regard to flow are known in air filter systems, for example. The secondary filter element serves as a safety element for protecting the clean side of the filter system, for example, when exchanging the primary filter element.

### SUMMARY

It is an object of the invention to provide an improved filter system with a secondary filter element and a primary filter element.

A further object of the invention is to provide a use of a secondary filter element in an improved filter system.

The aforementioned objects are solved according to an aspect of the invention by a filter system with a housing including a fluid inlet and a fluid outlet, wherein at least one primary filter element and one secondary filter element are arranged in the housing between the fluid inlet and the fluid outlet, wherein the secondary filter element is arranged in a hollow interior of the primary filter element, and wherein the primary filter element and the secondary filter element may be flowed through sequentially at least temporarily by a fluid to be filtered, for example a gaseous fluid, for example air, wherein the housing at the fluid outlet includes at least one coupling element for coupling to a coupling device arranged at the secondary filter element, wherein the secondary filter element includes a filter medium body permeable for the fluid to be filtered, which extends along a longitudinal axis and surrounds a hollow interior and which includes an open end and a closed end positioned oppositely along the longitudinal axis, wherein the filter medium body of the secondary filter element includes an adsorption agent, for example active carbon, wherein the coupling device is arranged at an open end of the filter medium body of the secondary filter element, wherein the coupling device is configured for a rotationally fixed coupling to the primary filter element and in that the at least one coupling element of the housing is configured as a thread and complementary to a thread of the coupling device of the secondary filter element, wherein the thread of the coupling device of the secondary filter element may be brought into engagement with the thread of the coupling element of the housing.

The objects according to a further aspect of the invention are solved by a use of a secondary filter element in a filter system, wherein the secondary filter element includes a filter medium body permeable for the fluid to be filtered, which extends along a longitudinal axis and surrounds a hollow interior and which includes an open end and a closed end positioned oppositely along the longitudinal axis, and wherein the filter medium body of the secondary filter element includes an adsorption agent, for example active carbon, wherein the secondary filter element is arranged in a hollow interior of the primary filter element of the filter system, and wherein the primary filter element and the secondary filter element are flowed through sequentially at least temporarily in operation of the filter system by a fluid to be filtered, for example a gaseous fluid, for example air, wherein the housing of the filter system includes at the fluid outlet at least one coupling element for coupling to a coupling device arranged at the secondary filter element, wherein the coupling device is arranged at an open end of the filter medium body of the secondary filter element, wherein the secondary filter element is coupled by the coupling device rotationally fixed to the primary filter element, and a thread of the coupling device of the secondary filter element is brought into engagement with the coupling element of the housing configured as a thread.

Embodiments and advantages of the invention are apparent from the description and the accompanying drawings.

According to an aspect, the invention is based on a filter system with a housing including a fluid inlet and a fluid outlet, wherein at least one primary filter element and one secondary filter element are arranged in the housing between the fluid inlet and the fluid outlet, wherein the secondary filter element is arranged in a hollow interior of the primary filter element, and wherein the primary filter element and the secondary filter element may be flowed through sequentially at least temporarily by a fluid to be filtered, for example a gaseous fluid, for example air. The housing includes at the fluid outlet at least one coupling element for coupling to a coupling device arranged at the secondary filter element. The secondary filter element includes a filter medium body permeable for the fluid to be filtered, which extends along a longitudinal axis and surrounds a hollow interior and which includes an open end and a closed end positioned oppositely along the longitudinal axis. The filter medium body of the secondary filter element includes an adsorption agent, for example active carbon. The coupling device is arranged at the open end of the filter medium body of the secondary filter element.

According to the invention, the coupling device is configured for rotationally fixed coupling to the primary filter element. The at least one coupling element of the housing is configured as a thread and complementary to a thread of the coupling device of the secondary filter element. In this context, the thread of the coupling device of the secondary filter element may be brought into engagement with the thread of the coupling element of the housing.

The secondary filter element is arranged downstream of the primary filter element in regard to flow and may additionally protect the clean side, for example, when the primary filter element is exchanged or with regard to substances that the primary filter element does not retain. The primary filter element and the secondary filter element may be exchanged independently of each other. In this way, different loading of the primary filter element and the secondary filter element may be taken into account so that an unnecessary exchange of the primary filter element or the secondary filter element may be avoided.

The secondary filter element may include an interface for coupling to the primary filter element and an interface for coupling to the housing of the filter system. The secondary filter element may be installed rotationally fixed in the housing in this way, even though significant mechanical loads and vibrations are acting on it in operation,

Since the filter medium body includes an adsorption agent, harmful gases which pass through the primary filter element, may be mostly removed from the fluid in the secondary filter element. This is for example beneficial when using the filter system in systems which include components which react sensitively to harmful gases. The filter system with the secondary filter element may be used in fuel cell systems in order to filter the cathode intake air. Harmful gases may degrade or even destroy the membranes between cathodes and anodes of the fuel cells.

The coupling device may be configured sleeve-shaped and include an interface for coupling to the primary filter element and a separate interface for coupling to the housing. The coupling to the primary filter element may be designed so as to be rotationally fixed. This may further improve the operational safety of the filter system with a secondary filter element.

The secondary filter element may be coupled, for example, by a thread to the filter housing which makes it, for example, possible to functionally upgrade in a simple manner existing filter systems with a conventional secondary filter element that have no gas adsorption functionality. The rotationally fixed coupling between the primary filter element and the secondary filter element may be used in this context to screw the secondary filter element into the housing-side thread, or unscrew it therefrom, indirectly via the primary filter element.

The at least one coupling element may be configured as a thread complementary to an outer thread of the threaded socket of the coupling device. This makes it possible to provide an advantageous rotationally fixed connection between the secondary filter element and the housing. As an alternative, a simple plug-in connection may be present.

According to an embodiment of the filter system, the primary filter element may include a filter medium body permeable for the fluid to be filtered which extends along a longitudinal axis and surrounds a hollow interior and which includes an open end and a closed end positioned oppositely along the longitudinal axis. The filter medium body of the primary filter element may include at its open end at least one coupling element for rotationally fixed coupling to the coupling device of the secondary filter element.

In operation, the secondary filter element may be arranged in the hollow interior of the primary filter element. The interface, i.e., coupling element and coupling device, between the primary filter element and the secondary filter element is arranged at the open end of the primary filter element and secondary filter element, respectively. A ring of polyurethane (PUR) may be arranged at the open end of the primary filter element.

According to an embodiment of the filter system, the coupling device of the secondary filter element may include a socket including the thread at the open end of the filter medium body of the secondary filter element. For example, the thread may be an outer thread. For example, the socket may project alternatively or additionally past the open end of the filter medium body of the secondary filter element.

A seal surface for a seal element may be arranged at the socket of the coupling device so that the clean side in the interior of the secondary filter element is sealed in relation to the raw side of the filter element.

This interface for coupling to the housing may be arranged at the sleeve-shaped coupling device axially spaced apart from the interface to the primary filter element. The coupling device may be screwed with the outer thread into a complementary thread of the housing, for example at an outlet socket for the filtered fluid. The secondary filter element may be connected stably, for example rotationally fixed, to the housing in this way. As an alternative, it is possible that the secondary filter element is plugged into the housing, for example into the outlet socket for the filtered fluid. In this case, a thread is unnecessary.

According to an embodiment of the filter system, the coupling device may include axially extending ribs, for example at an outer wall surface, which for example may be slanted in relation to the longitudinal axis in direction toward the closed end of the filter medium body of the secondary filter element. The ribs may prevent a relative rotation between the primary filter element and secondary filter element.

As an alternative or in addition, the coupling device may include axial recesses, for example at an outer wall surface. The axial recesses may be designed complementary in shape to projections at the inner circumference of the primary filter element.

According to an embodiment of the filter system, the ribs and/or recesses may be arranged adjacent to an outer wall surface of the filter medium body of the secondary filter element and/or overlap the filter medium body of the secondary filter element in relation to the longitudinal axis.

According to an embodiment of the filter system, the coupling device of the secondary filter element may include a groove in which the filter medium body is immersed. The groove may be located at the outer wall surface of the coupling device.

According to an embodiment of the filter system, the ribs may be present at an outer side of an outer groove wall of the groove. In this way, the primary filter element, for example, with an open elastic end disc, may be easily pushed in axial direction across the groove wall. As an alternative or in addition, the axial recesses may be present at an outer side of an outer groove wall of the groove.

According to an embodiment of the filter system, the at least one coupling element of the primary filter element may include at least one projection which projects with a radial component into the interior and is configured for contacting at least one of the axially extending ribs of the coupling device of the secondary filter element in order to effect the rotationally fixed coupling of the coupling element of the primary filter element to the coupling device of the secondary filter element. In this context, the projection at the inner circumference of the primary filter element may engage the axial recesses at the coupling device of the secondary filter element and further improve the rotationally fixed coupling.

The at least one coupling element of the primary filter element may be configured to be complementary in shape to at least one axial recess at the coupling device of the secondary filter element. Upon mounting, the at least one projection may be inserted into the axial recess of the coupling device of the secondary filter element. When the coupling device of the secondary filter element includes outwardly facing ribs, a rotationally fixed connection may be created. The at least one projection may be formed of PUR.

According to an embodiment of the filter system, the coupling element of the primary filter element may include at least two projections which project with a radial component into the interior, respectively, and are spaced apart in a circumferential direction. A plurality of projections may be arranged, for example, equidistantly relative to each other, and may engage corresponding axial recesses of the secondary filter element. For example, the coupling element of the primary filter element may be configured to be complementary in shape to at least one axial recess of the coupling device of the secondary filter element. In this context, the projections at the inner circumference of the primary filter element may engage the axial recesses at the coupling device of the secondary filter element and may further improve the rotationally fixed coupling.

According to an embodiment of the filter system, the filter medium body of the secondary filter element may include a folded filter medium with adsorption agent. As an alternative, the filter medium body of the secondary filter element may include a wound filter medium with adsorption agent. For example, the adsorption agent, for example active carbon, may be introduced and fixed between two nonwoven layers, which then are wound or folded. Optionally, the adsorption agent may also be present as loose fill between nonwoven layers.

According to an embodiment of the filter system, the filter medium body of the secondary filter element may include at its outer side and/or inner side a reinforcement element, for example a grid. This allows for a horizontal installation of the filter element. The reinforcement element may protect the surface of the secondary filter element from damage when the primary filter element is to be pulled off the secondary filter element, for example, when exchanging the primary filter element.

According to an embodiment of the filter system, at the closed end of the filter medium body of the secondary filter element, an end disc may be arranged which may include for example a depression as a mounting aid. The depression may serve to apply a corresponding tool in order to unscrew the secondary filter element from the housing or screw it into the housing.

According to an embodiment of the filter system, the housing may include an outlet socket for particles. Particles, such as dust, which are separated at the primary filter element, may be collected and removed through the outlet socket for particles.

According to an embodiment of the filter system, the outlet socket may include a closure element, which opens and closes weight-dependently. The closure element may be designed as a pivotable flap. As soon as a certain quantity of particles has collected on the flap, the flap opens automatically so that the particles can fall out of the outlet socket. When no weight is loading the flap anymore, the latter can close again. As an alternative, the closure element may also be designed as a valve.

According to a further aspect of the invention, a use of a secondary filter element in a filter system is proposed, wherein the secondary filter element includes a filter medium body permeable for the fluid to be filtered, which extends along a longitudinal axis and surrounds a hollow interior and which includes an open end and a closed end positioned oppositely along the longitudinal axis. In this context, the filter medium body of the secondary filter element includes an adsorption agent, for example active carbon. The secondary filter element is arranged in a hollow interior of a primary filter element of the filter system, and the primary filter element and the secondary filter element, in operation of the filter system, are flowed through sequentially at least temporarily by a fluid to be filtered, for example a gaseous fluid, for example air. The housing of the filter system includes at the fluid outlet at least one coupling element for coupling to a coupling device which is arranged at the secondary filter element, wherein the coupling device is arranged at an open end of the filter medium body of the secondary filter element. In this context, the secondary filter element is coupled by the coupling device rotationally fixed to the primary filter element, and a thread of the coupling device of the secondary filter element is brought into engagement with the coupling element of the housing embodied as a thread.

The secondary filter element is arranged downstream of the primary filter element in regard to flow and may protect the clean side additionally, for example, when the primary element is exchanged or against substances that are not retained by the primary filter element. The primary filter element and the secondary filter element may be exchanged independently of each other. In this way, different loading of the primary filter element and the secondary filter element may be taken into account so that an unnecessary exchange of the primary filter element or the secondary filter element may be avoided.

The secondary filter element may include an interface for coupling to the primary filter element and an interface for coupling to the housing of the filter system. The secondary filter element in this way may be installed rotationally fixed in the housing, even though significant mechanical loads and vibrations act on it in operation.

Since the filter medium body includes an adsorption agent, harmful gases which pass through the primary filter element may be mostly removed from the fluid in the secondary filter element. This is for example beneficial when using the filter system in systems which include components which react sensitively to harmful gases. Consequently, the filter system with the secondary filter element may be used in fuel cell systems in order to filter the cathode intake air. Harmful gases may degrade or even destroy the membranes between cathodes and anodes of the fuel cells.

The coupling device may be designed in a sleeve shape and include an interface for coupling to the primary filter element and a separate interface for coupling to the housing. The coupling to the primary filter element may be designed to be rotationally fixed. This may further improve the operational safety of the filter system with a secondary filter element.

The secondary filter element, for example, may be coupled by a thread to the filter housing which makes it for example possible to functionally upgrade in a simple manner existing filter systems with a conventional secondary filter element that have no gas adsorption functionality.

The at least one coupling element may be configured as a thread complementary to an outer thread of a threaded socket of the coupling device. This allows for an advantageous rotationally fixed connection between the secondary filter element and the housing. As an alternative, a simple plug-in connection may be present.

According to an embodiment, the thread of the coupling device of the secondary filter element may be brought into engagement with the coupling element of the housing embodied as a thread by rotating the primary filter element, wherein a rotational movement of the primary filter element may be transmitted to the coupling device of the secondary filter element via the rotationally fixed coupling of the coupling device of the secondary filter element to the primary filter element.

The rotationally fixed coupling between the primary filter element and the secondary filter element may be used in this context for screwing the secondary filter element into the housing-side thread, or unscrewing it, indirectly by the primary filter element.

### BRIEF DESCRIPTION OF THE DRAWINGS

Other advantages will be made apparent from the following drawing description. In the drawings embodiments of the invention are illustrated. The drawings and the following detailed description contain numerous features in combination. A person of skill in the art will consider the features expediently also individually and combine them to expedient further combinations.

FIG. 1 shows an isometric view of a housing of a filter system according to an embodiment of the invention.

FIG. 2 shows a section illustration through the filter system according to FIG. 1 with interfaces.

FIG. 3 shows a section illustration of an embodiment of the housing of the filter system according to FIG. 1.

FIG. 4 shows a detail illustration of the interfaces between the primary filter element, the secondary filter element, and the housing of the filter system of FIG. 2.

FIG. 5 shows an isometric illustration of a secondary filter element according to an embodiment of the invention.

FIG. 6 shows a further isometric illustration of the secondary filter element of FIG. 5.

FIG. 7 shows an isometric illustration of a primary filter element according to an embodiment of the invention.

FIG. 8 shows a further isometric illustration of the primary filter element of FIG. 7.

### DETAILED DESCRIPTION

In the drawing figures, same or same-type components are identified with like reference characters. The drawing figures show only examples and are not to be understood as limiting.

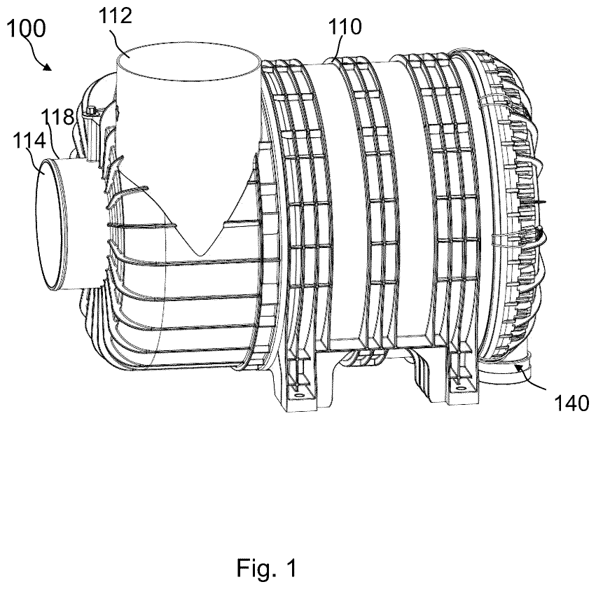

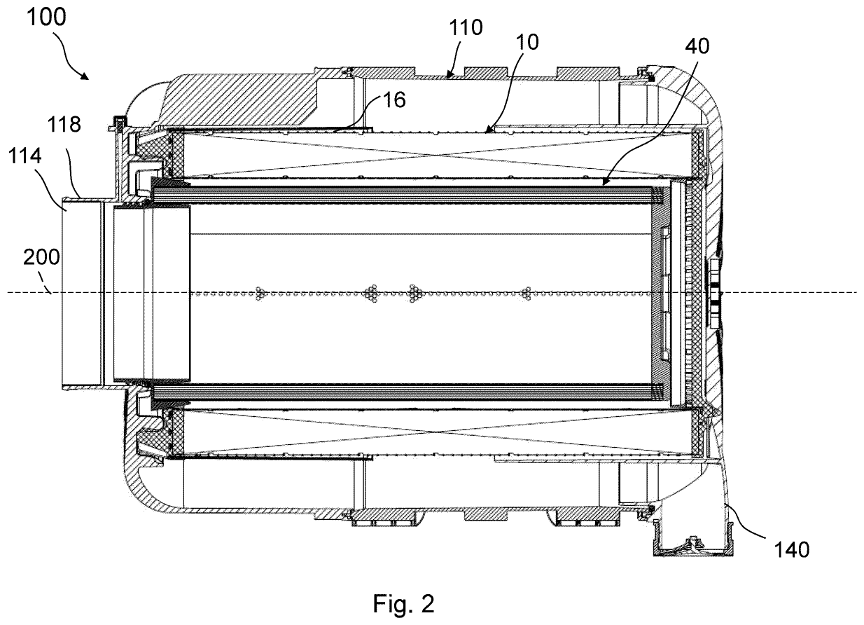

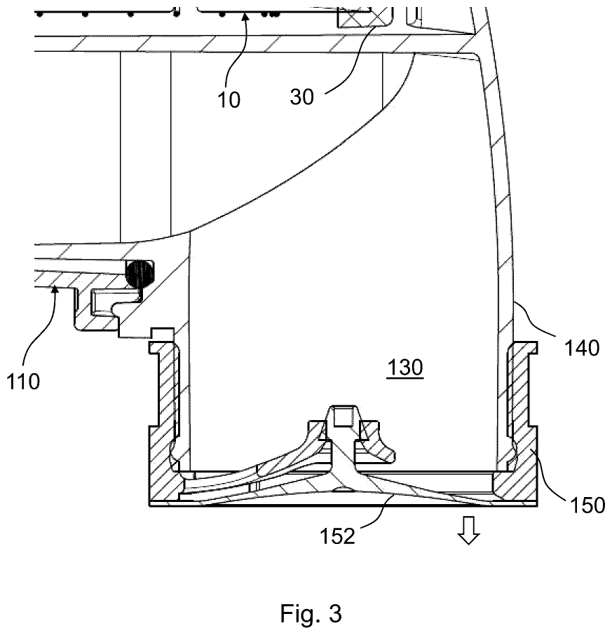

For explaining the invention, FIGS. 1 through 4 show a filter system 100 according to an embodiment of the invention, wherein FIG. 1 shows an isometric view of the housing 110 of the filter system and FIG. 2 a section illustration through the filter system 100 according to FIG. 1 with interfaces between a secondary filter element 40 and a primary filter element 10 and the secondary filter element 40 and the housing 110. FIG. 3 shows a detail of an outlet socket 140 for discharging particles from the housing 110.

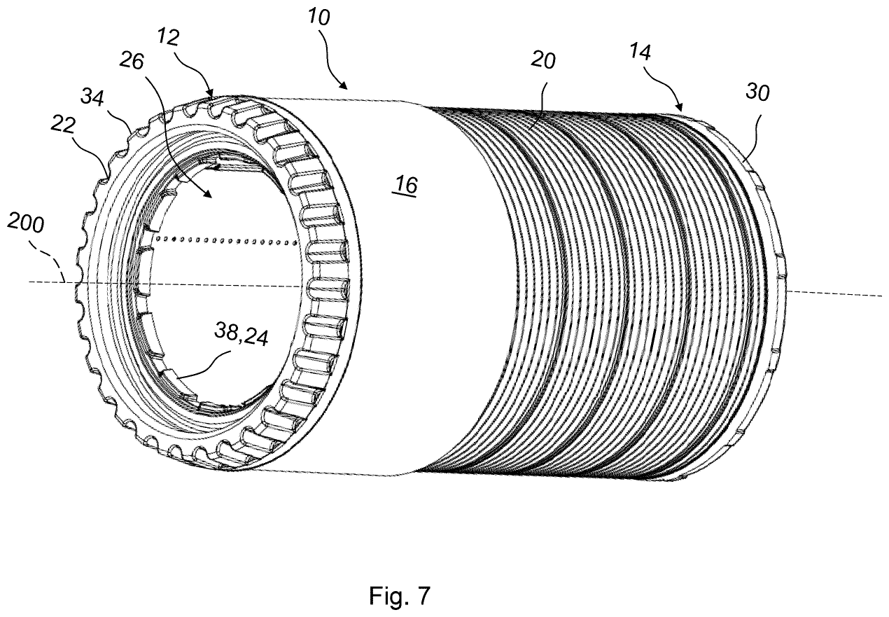

In the housing 110, the primary filter element 10 is arranged in whose hollow interior 26 (see FIG. 7) the secondary filter element 40 is arranged. When the primary filter element 10 is removed from the housing, the secondary filter element 40 protects the clean side of the filter system 100.

The housing 110 comprises a fluid inlet 112 and a fluid outlet 114 between which the primary filter element 10 and the secondary filter element 40 are arranged in normal operation in flow direction of the fluid to be filtered, for example, air.

The fluid inlet 112 is arranged tangentially in this embodiment so that the fluid enters the housing 110 tangentially and a preseparation of particles, for example, dust, may be realized. The primary filter element 10 comprises a circumferential shroud 16 in the region of the fluid inlet 112 as an inflow protection.

The fluid outlet 114 is arranged centrally in this example and guides the filtered fluid with a socket 118 out of the filter system 100.

The housing 110 is arranged in this example such that the primary filter element 10 and the secondary filter element 40 are arranged horizontally. This is a frequent installation situation, for example, in cathode air filter systems of fuel cells. In the lower region of the housing 110, a collection chamber 130 for particles is arranged (FIG. 3) which may be discharged via an outlet socket 140. For this purpose, a closure device 150 in the form of a cap is pushed onto the outlet socket 140 which comprises a flap as a closure element 152 which opens weight-dependently and, after the collection chamber 130 has emptied, closes again by a spring force, for example. In an installation position deviating from the intended one of the filter system 100, the position of the outlet socket 140 may be correspondingly selected appropriately.

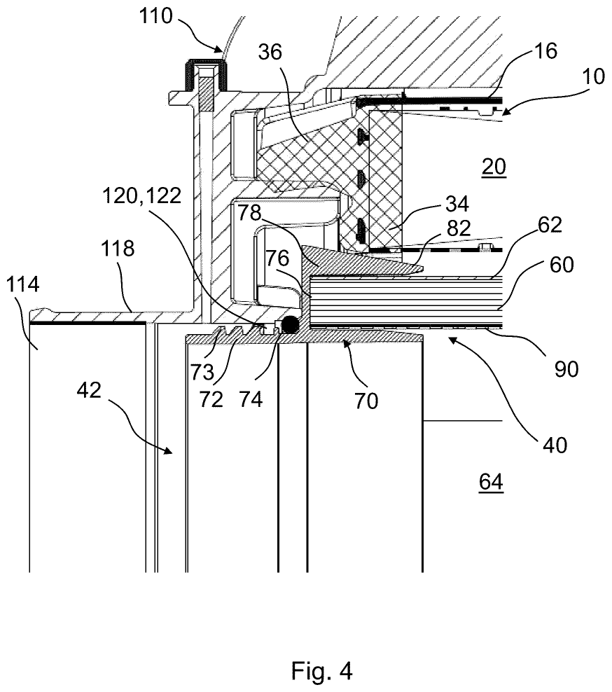

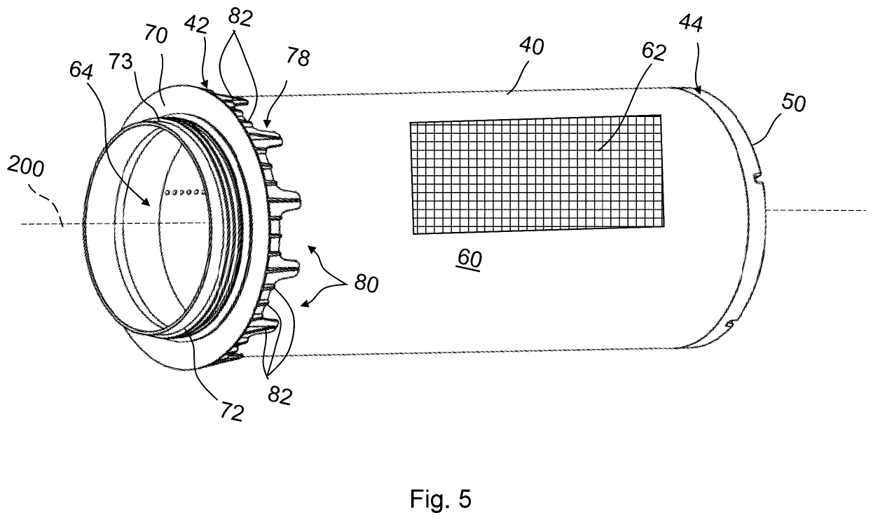

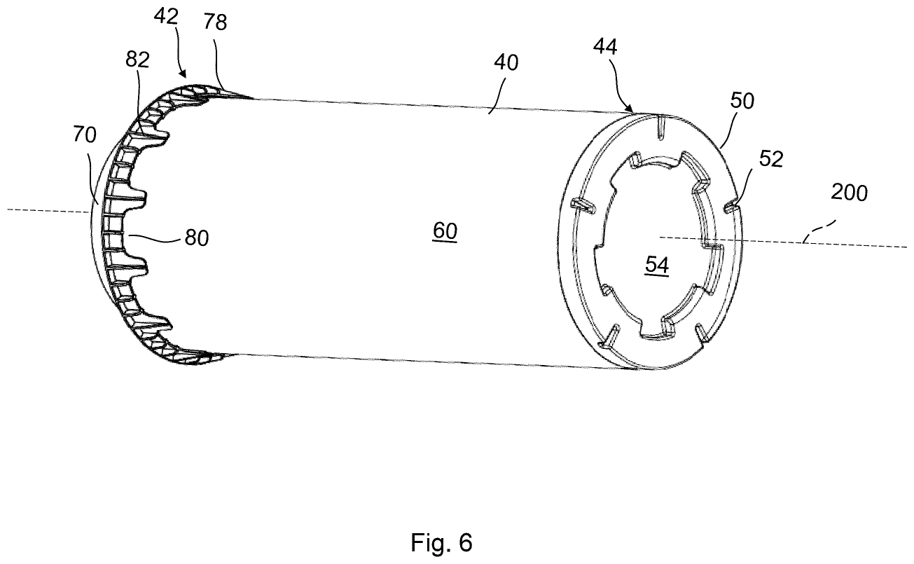

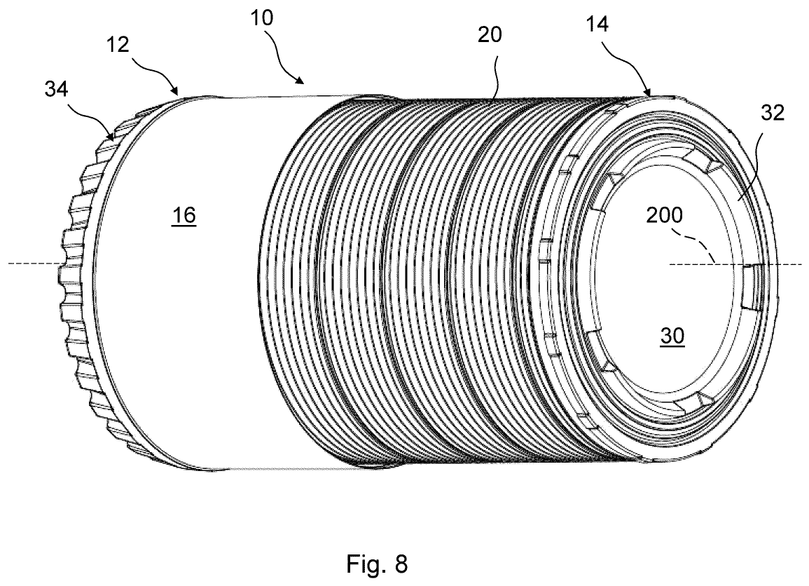

FIG. 4 shows a detailed illustration of the interfaces between the primary filter element 10, the secondary filter element 40, and the housing 110 of the filter system 100 of FIG. 2. FIGS. 5 and 6 show different views of the secondary filter element 40 according to an embodiment of the invention and FIGS. 7 and 8 different views of the primary filter element 10 according to an embodiment of the invention, in isometric illustration, respectively.

The fluid outlet 114 comprises a coupling element 120 for coupling to a coupling device 70 which is arranged at the secondary filter element 40. The coupling element 120 in this embodiment (FIG. 4) is configured as a thread 122 at the inner circumference of the fluid outlet 114 complementary to an outer thread 73 of the threaded socket 72 of the coupling device 70.

The secondary filter element 40 comprises a filter medium body 60 which is permeable for the fluid to be filtered, for example a gaseous fluid, for example air, and which extends along a longitudinal axis 200 and surrounds a hollow interior 64 and which comprises an open end 42 and a closed end 44 positioned oppositely along the longitudinal axis 200 (FIGS. 5 and 6). The filter medium body 60 comprises an adsorption agent, for example active carbon.

The filter medium body 60 may comprise a folded filter medium with adsorption agent or a wound filter medium with adsorption agent. The filter medium body 60 may expediently surround a support tube 90. The filter medium body 60 may comprise at its outer wall a reinforcement element 62 which is embodied as a grid, for example. This may be seen in the detailed view of FIG. 4 and in FIG. 5 symbolically as a detail. Of course, the outer wall may be surrounded completely by the reinforcement element 62. The reinforcement element 62 protects the filter medium body 60 from damage, for example, in case of element exchange. As an alternative, the reinforcement element 62 may be present at the inner side of the filter medium body 60.

At the closed end 44 of the filter medium body 60, an end disc 50 is arranged which comprises a depression 54 with radial cutouts and/or notches 52 as a mounting aid. Here, as needed, a corresponding tool for mounting and demounting of the secondary filter element 40 may be applied.

The coupling device 70 is arranged at the open end 42 of the filter medium body 60 and comprises interfaces, on the one hand, to the housing 110 and, on the other hand, to the primary filter element 10. They are located expediently at the outer side of the coupling device 70.

The coupling device 70 is embodied in a sleeve shape. The filter medium body 60 of the secondary filter element 40 is immersed with support tube 90 into a circumferential groove 76 of the coupling device 70 and, for example, is glued or potted therein. At an outer side of the outer groove wall 78 of the groove 76, the coupling device 70 comprises axial recesses 80. The outer side of the outer groove wall 78 comprises in addition axially extending ribs 82 which are slanted in relation to the longitudinal axis 200 in direction toward the closed end 44. The outer groove wall 78, for example the axial recesses 80 therein, form the interface to the primary filter element 10, as seen in FIG. 4. The primary filter element 10 may be pushed across the outer side of the groove wall 78.

The axial recesses 80 at the coupling device 70 of the secondary filter element 40 and the corresponding projections 24 at the primary filter element 10 have furthermore the advantage that a coding of the primary filter element 10 and the secondary filter element 40 is possible thereby.

The primary filter element 10 comprises a filter medium body 20 permeable for a fluid to be filtered, for example a gaseous fluid, for example air, which extends along a longitudinal axis 200 and surrounds a hollow interior 26 and which comprises an open end 12 and a closed end 14 oppositely positioned along the longitudinal axis 200 (FIGS. 7 and 8). At the open end 12, the primary filter element 10 comprises an open end disc 34, for example of PUR, which may comprise an axially extending seal 36. At the closed end 14, a closed end disc 30 or a cover or the like is arranged.

The filter medium body 20 of the primary filter element 10 comprises at its open end 12, circumferentially extending at its inner circumference, a plurality of coupling elements 38 for coupling to the coupling device 70 of the secondary filter element 40.

The coupling elements 38 are designed as projections 24 which project into the interior 26 and are designed complementary in shape to the axial recesses 80 at the coupling device 70 of the secondary filter element 40. The coupling elements 38 may be integral components of the open end disc 34. At the outer circumference of the open end disc 34, recesses 22 are arranged circumferentially.

When the primary filter element 10 is pushed across the coupling device 70 of the secondary filter element 40, the ribs 82 at the outer side of the groove wall 78 of the coupling device 70 dig into the relatively elastic material of the open end disc 34 and form a rotationally fixed connection to the primary filter element 10. The recesses at the outer circumference of the open end disc 34 further support the stability against undesirable rotations in operation of the filter system 100.

The filter medium body 20 of the primary filter element 10 may be wound or folded in a star shape and comprise at its outer circumference stabilizing string coils, which may be seen in FIGS. 7 and 8 above the shroud 16.

At the closed end disc 30, which may also be for example formed of PUR, spacers 32 are arranged projecting in axial direction.

Furthermore, the coupling device 70 of the secondary filter element 40, at the open end 42 of the filter medium body 60 of the secondary filter element 40, comprises a threaded socket 72 for coupling to the housing 110 of the filter system 100. The threaded socket 72 extends in the direction of the longitudinal axis 200 away from the groove 76. At the threaded socket 72, an outer thread 73 is formed which is for example visible in FIGS. 4 and 5. In this way, the secondary filter element 40 may be screwed into the socket 118 of the fluid outlet 114 and unscrewed therefrom. This also improves the rotationally fixed arrangement of the secondary filter element 40 during operation of the filter system 100.

The secondary filter element 40 may be coupled directly by the thread 73 to the filter housing 110 in this manner, which for example makes it possible to functionally retrofit in a simple manner existing filter systems with a conventional secondary filter element having no gas adsorption functionality. The rotationally fixed coupling between the primary filter element 10 and the secondary filter element 40 may be used in this context for screwing the secondary filter element 40 into the housing-side thread 122, or unscrewing it, indirectly by the primary filter element 10.

As an alternative, a simple plug-in embodiment without thread is possible (not illustrated).

As seen in FIG. 4, between the thread 73 at the threaded socket 72 and the groove 76 of the coupling device 70 of the secondary filter element 40, a seal ring 74 is arranged with which a sealing action between clean side and raw side of the filter system 100 is made possible, for example in case the primary filter element 10 is pulled off the secondary filter element 40.

### REFERENCE CHARACTERS

10 primary filter element
12 open end
14 closed end
16 shroud
20 filter medium body
22 recesses
24 projection
26 interior
30 closed end disc
32 spacers
34 open end disc
36 seal
38 coupling element
40 secondary filter element
42 open end
44 closed end
50 end disc
52 notches
54 depression
60 filter medium body
62 reinforcement element
64 interior
70 coupling device
72 threaded socket
73 thread
74 seal
76 groove
78 outer groove wall
80 recess
82 rib
90 support tube
100 filter system
110 housing
112 fluid inlet
114 fluid outlet
118 socket
120 coupling element
122 thread
130 collection chamber
140 outlet socket
150 closure device
152 closure element
200 longitudinal axis

1. A filter system comprising:
a housing comprising a fluid inlet and a fluid outlet;
a primary filter element and a secondary filter element arranged in the housing between the fluid inlet and the fluid outlet, wherein the secondary filter element is arranged in a hollow interior of the primary filter element and wherein the secondary filter element comprises a coupling device;
wherein the primary filter element and the secondary filter element are configured to be flowed through sequentially by a fluid to be filtered;
wherein the housing comprises at least one coupling element disposed at the fluid outlet and configured to couple to the coupling device of the secondary filter element;
wherein the secondary filter element comprises a filter medium body permeable for the fluid to be filtered, wherein the filter medium body of the secondary filter element extends along a longitudinal axis and surrounds a hollow interior of the secondary filter element, wherein the filter medium body of the secondary filter element comprises an open end and a closed end positioned oppositely to the open end along the longitudinal axis;
wherein the filter medium body of the secondary filter element comprises an adsorption agent;
wherein the coupling device of the secondary filter element is arranged at the open end of the filter medium body of the secondary filter element;
wherein the coupling device of the secondary filter element is configured to be coupled rotationally fixed to the primary filter element;
wherein the coupling device of the secondary filter element comprises a thread and wherein the at least one coupling element of the housing comprises a thread complementary to the thread of the coupling device of the secondary filter element; and
wherein the thread of the coupling device of the secondary filter element is configured to engage the thread of the at least one coupling element of the housing.

2. The filter system according to claim 1, wherein the primary filter element comprises a filter medium body permeable for the fluid to be filtered, wherein the filter medium body of the primary filter element extends along the longitudinal axis and surrounds the hollow interior of the primary filter element, and wherein the filter medium body of the primary filter element comprises an open end and a closed end positioned oppositely to the open end along the longitudinal axis;
wherein the primary filter element comprises at least one coupling element disposed at the open end of the filter medium body of the primary filter element, wherein the at least one coupling element of the primary filter element is configured to be coupled rotationally fixed to the coupling device of the secondary filter element.

3. The filter system according to claim 1, wherein the coupling device of the secondary filter element comprises a socket disposed at the open end of the filter medium body of the secondary filter element, wherein the thread of the coupling device of the secondary filter element is arranged at the socket.

4. The filter system according to claim 3, wherein the thread of the coupling device of the secondary filter element is an outer thread and/or wherein the socket projects past the open end of the filter medium body of the secondary filter element.

5. The filter system according to claim 3, wherein the coupling device of the secondary filter element comprises an outer wall surface and axially extending ribs arranged at the outer wall surface.

6. The filter system according to claim 5, wherein the axially extending ribs are slanted in relation to the longitudinal axis in a direction of the closed end of the filter medium body of the secondary filter element.

7. The filter system according to claim 5, wherein the axially extending ribs are arranged adjacent to an outer wall surface of the filter medium body of the secondary filter element.

8. The filter system according to claim 5, wherein the axially extending ribs overlap the filter medium body of the secondary filter element in relation to the longitudinal axis.

9. The filter system according to claim 3, wherein the coupling device of the secondary filter element comprises an outer wall surface, and wherein the coupling device of the secondary filter element comprises axial recesses arranged at the outer wall surface of the secondary filter element.

10. The filter system according to claim 9, wherein the axial recesses are arranged adjacent to an outer wall surface of the filter medium body of the secondary filter element and/or overlap the filter medium body of the secondary filter element in relation to the longitudinal axis.

11. The filter system according to claim 1, wherein the coupling device of the secondary filter element comprises a groove, and wherein the filter medium body of the secondary filter element is immersed in the groove.

12. The filter system according to claim 11, wherein the groove comprises a groove wall comprising an outer side, and wherein the coupling device of the secondary filter element comprises axially extending ribs arranged at the outer side of the outer groove wall of the groove and/or comprises axial recesses at the outer side of the outer groove wall of the groove.

13. The filter system according to claim 12, wherein the primary filter element comprises at least one coupling element comprising one or more projections, and wherein the one or more projections project with a radial component into the hollow interior of the primary filter element and are configured to contact at least one of the axially extending ribs of the coupling device of the secondary filter element and to couple rotationally fixed the at least one coupling element of the primary filter element to the coupling device of the secondary filter element.

14. The filter system according to claim 13, wherein the one or more projections include at least two projections spaced apart from each other in a circumferential direction, and wherein the at least two projections are configured complementary in shape to at least one of the axial recesses of the coupling device of the secondary filter element arranged at the outer side of the outer groove wall of the groove.

15. The filter system according to claim 1, wherein the filter medium body of the secondary filter element comprises a folded filter medium comprising the adsorption agent or comprises a wound filter medium comprising the adsorption agent.

16. The filter system according to claim 1, wherein the filter medium body of the secondary filter element comprises a reinforcement element arranged at an outer side and/or an inner side of the filter medium body of the secondary filter element.

17. The filter system according to claim 1, wherein an end disc is arranged at the closed end of the filter medium body of the secondary filter element, wherein the end disc comprises a depression as a mounting aid.

18. The filter system according to claim 1, wherein the housing comprises an outlet socket for particles.

19. A method of using a secondary filter element in a filter system, wherein the secondary filter element comprises a filter medium body permeable for a fluid to be filtered, wherein the filter medium body extends along a longitudinal axis and surrounds a hollow interior, wherein the secondary filter element comprises an open end and a closed end positioned oppositely to the open end along the longitudinal axis, wherein the filter medium body comprises an adsorption agent, wherein the secondary filter element is arranged in a hollow interior of a primary filter element of the filter system, wherein the primary filter element and the secondary filter element in operation of the filter system are flowed through sequentially by the fluid to be filtered, wherein a housing of the filter system comprises, at a fluid outlet, at least one coupling element, wherein the secondary filter element comprises a coupling device arranged at the open end of the filter medium body; the method comprising:
coupling the secondary filter element via the coupling device to the primary filter element in a rotationally fixed coupling;
engaging a thread of the coupling device of the secondary filter element with a thread of the at least one coupling element of the housing of the filter system to couple the secondary filter element to the housing of the filter system.

20. The method according to claim 19, further comprising threading the thread of the coupling device of the secondary filter element into the thread of the coupling element of the housing by rotating the primary filter element, wherein a rotational movement of the primary filter element is transmitted to the coupling device of the secondary filter element by the rotationally fixed coupling of the secondary filter element to the primary filter element.
